(19) United States
(12) Patent Application Publication
(10) Pub. No.: US 2013/0034239 A1
(43) Pub. Date: Feb. 7, 2013

(54) EAR MICROPHONE

(71) Applicant: Doo Sik Shin, Seoul (KR)

(72) Inventor: Doo Sik Shin, Seoul (KR)

(21) Appl. No.: 13/642,486

(22) PCT Filed: Jan. 17, 2011
(86) PCT No.: PCT/KR11/00328

§ 371 Date: Oct. 19, 2012

(30) Foreign Application Priority Data
Apr. 19, 2010 (KR) 10-2010-0035835
May 24, 2010 (KR) 10-2010-0048008
May 24, 2010 (KR) 10-2010-0048013

(51) Int. Cl. H04R 1/10

(52) U.S. Cl. 381/74

(57) ABSTRACT

The present invention relates to an ear microphone for providing clear sound by preventing echo and howling phenomena by blocking external noise, and for providing an effective telephone call in a noisy environment by improving the recognition ability of a voice-recognizing device. For the ear microphone, a connector for connection to an external device, a control unit for controlling the ear microphone overall, and an earphone unit to be worn by a user for outputting or inputting voice are electrically connected to each other through cables. The earphone unit consists of a first earphone unit which includes first and second speakers wearable on the ear, a first microphone having directivity, and a second earphone unit which includes a third speaker. For the control unit, a grounding terminal and one terminal of the control unit are connected to the connector such that the other terminal is connected to the first to third speakers, and one terminal is connected to the connector such that the other terminal is connected to the first microphone. The microphone output terminal is configured to be connected to a resistor in series. The third speaker is configured as a voltage-dividing resistor on a speaker input terminal. Each voltage dividing resistor is differently designed for the first and second speakers such that the second speaker has phase characteristics that are opposite those of the first speaker, and at the same time has a voltage different from the first speaker. A negative terminal of the first speaker and a positive terminal of the second speaker connected to the speaker output terminal are connected to a volume-adjusting unit.

### FIELD OF THE INVENTION

The present invention relates to an ear microphone, more particularly, an ear microphone which allows hearing of a clear sound to be heard by blocking the phenomena of echo and howling by blocking external noise when voice signal provided through the ear is provided to the counterpart or a voice-recognizing device is controlled and allows an effective telephone call in a noisy environment by increasing the degree of recognition of the voice-recognizing device

### DESCRIPTION OF RELATED ART

In general, as illustrated in FIG. 1, an ear microphone is used by being worn on the ear of user while coupled to an external device (1) such as acoustic device or mobile phone for hearing of the sound and communication of voice signal.

Referring to FIG. 1 of the attached drawings, there are provided a speaker (2) having a shape for allowing the speaker to be introduced into the ear of user and outputting the voice signal from a surface facing the ear of user and a microphone (3) for converting the voice signal transmitted through an external auditory cannel in the ear into electrical signal and then outputting it to the external device (1) through a connector.

By the way, in the case of the construction as described above, if voice-outputting direction of the speaker (2) and signal-inputting direction of the microphone (3) are commonly opposite to each other with respect to the external auditory cannel for reducing echo and oscillation, the voice coming out from the ear is input into the microphone through a long transmission path, thus there is a problem that the voice is heard by a counterpart in a low volume, hence a difficult occurs in telephone call.

FIG. 2 is a view showing a schematic construction of a conventional ear microphone (10).

As illustrated in FIG. 2, the ear microphone (10) comprises a connector (11) coupled with an external device (1), a control unit (12) for setting a use mode of the ear microphone and also controlling overall operation of the ear microphone (10), and an earphone unit (13) worn on the ear of user and carrying out voice-outputting or inputting process.

Here, the earphone unit (13) is comprised of first and second earphone part (13A, 13B) worn on both ears of user. The first earphone part (13A) is provided with a first speaker (S1) and microphone (M), and the second earphone part (13B) is provided with a second speaker (S2). That is to say, the voice signal provided from the external device (1) is transmitted to the ear of user through the first and second speakers (S1, S2) provided in the first and second earphone parts (13A, 13B). Also, the voice signal of user is transmitted to the microphone (M) through the external auditory cannel of the ear and then provided to the external device (1).

Furthermore, the control unit (12) comprises a mode selection part (12a) for selecting services provided in relation with the external device (1) coupled to the connector (11), i.e., a hearing mode or a communication mode. That is to say, depending on a mode selected by the mode selection part (12a), the control unit (12) carries out signal transmission/reception process on a signal outputted through the first and second speakers (S1, S2) and a signal inputted from the microphone (M).

The microphone (M) of the ear microphone (10) amplifies the signal provided from the ear of user and then converts it to electrical signal and thereafter provides the latter to the external device (1); in this case, at the time of telephone call with the counterpart, the voice of the counterpart is outputted from the speaker and again inputted into the microphone, thus the phenomenon of echo or oscillation may occur.

FIG. 3 is a view showing a schematic construction of another conventional ear microphone (20). As illustrated in FIG. 3, the ear microphone (20) is comprised of a connector (21) for coupling with the external device (1), a control unit (22) for controlling the ear microphone (20) overall, and an earphone unit (23) worn on the ear of user and carrying out the voice-outputting or inputting process. Here, the connector (21), control unit (22) and earphone unit (23) are electrically connected to one another through certain cables.

The connector (21) may be in any various forms allowing connection to the external device (1). The connector (21) provides signal provided from the external device (1) to the control unit (22), and provides signal provided through the control unit (22) to the external device (1).

The control unit (22) comprises a second microphone (M2) and a volume-adjusting unit for adjusting the volume of voice signal output by a speaker provided in the earphone unit (23). In this connection, the second microphone (M2) is positioned so as to be exposed to the outside and receives the voice signal provided from the mouth of user and is comprised of a microphone having no directional property.

The earphone unit (23) is comprised of first and second earphone parts (23a, 23b) of a shape allowing the parts to be worn on both ears of user. The first earphone part (23a) is provided with a first speaker (S1) and first microphone (M1), and the second earphone part (23b) is provided with a second speaker (S2). The first microphone (M1) is provided with, as input signal, signal generated from the ear when the user talks, and is comprised of a microphone having a directional property. That is to say, the voice signal provided from the external device (1) is transmitted to the ears of user through the first and second speakers (S1, S2) provided in the first and second earphone parts (23a, 23b). Also, the voice signal of user is transmitted to the first microphone (M1) through the external auditory cannel of the ear and then provided to the external device (1). In the case of such a construction, since telephone call is made using the external microphone (M2) in a quiet place, there is no concern of occurrence of the phenomenon of echo or howling, but since the voice is transmitted to the counterpart through the internal microphone (M1) in a very noisy place, it is difficult to eliminate the phenomena of echo and howling due to the integration of the speaker (S1) and microphone (M1).

Furthermore, in FIGS. 2 and 3 showing the prior arts, there is a problem that since a dynamic speaker is used, the speaker cannot be completely shielded, thus the voice is not clearly transmitted, and there is inconvenience that the microphone has to be manually selected.

### SUMMARY OF THE PRESENT INVENTION

The present invention has been devised to solve the above-mentioned problems of prior arts, and its object is to provide an ear microphone which by utilizing a second self-balanced (BA-type Balanced Armature) speaker (S2) of closed type having different phase and voltage, controls a disadvantage of the phenomenon of echo occurring since output of a first self-balanced (BA-type Balanced Armature) speaker (S1) of closed type is too high and thus the output of the first speaker is introduced into input of microphone (M) and by adjusting the output of microphone (M), controls occurrence of the phenomenon of howling in the case of high output of the microphone, thereby providing a clear telephone call even in a noisy environment.

Furthermore, another object of the present invention is to provide an ear microphone which at a place where the ambient noise is severe, provides the external device with the voice signal provided from the ear of user and separates a self-balanced speaker of closed type and a directional microphone, thereby fundamentally eliminating the echo and howling and can completely close the speaker by using the self-balanced speaker of closed type, thus can block ambient noise coming from the outside, therefore, allows an telephone call even in a noisy environment and so can drastically improve the degree of voice recognition of the voice-recognizing device.

Furthermore, yet another object of the present invention is to provide an ear microphone which selects the microphones by automatically detecting the level of noise as voice signal depending on the level of ambient noise, thus can avoid stuffiness in the ear which is caused when the user continuously makes a telephone call by ear.

Furthermore, yet another object of the present invention is to provide an ear microphone which blocks the phenomena of echo and howling to allow hearing of clear sound by orientating a voice-outputting terminal of the speaker and signal-inputting terminal of the microphone in the same direction with respect to the external auditory cannel and/or an open part of a housing.

However, the object of the present invention is not limited to the above-mentioned objects, and other objects not mentioned can be clearly understood from the following description by persons skilled in the art.

According to features of the present invention for achieving the above-mentioned objects, an ear microphone is provided which comprises a connector for coupling with an external device; a control unit for controlling the ear microphone overall; and an earphone unit worn on the ear of user and carrying out voice-outputting or inputting process, wherein the connector, control unit and earphone unit are electrically connected to one another through cables, and the earphone unit has a shape allowing it to be worn on the ear of user and comprises a first earphone part which includes first and second self-balanced speakers (S1, S2) of closed type and a first microphone having a directional property and a second earphone part which includes a third self-balanced speaker (S3) of closed type.

In this connection, according to additional feature of the present invention, the control unit comprises a ground terminal, a element of which one end is coupled with the connector and of which the other end is coupled with the first, second and third speakers, and an element of which one end is coupled with the connector and of which the other end is coupled with the first microphone, and an output terminal of the microphone is connected to a resistor in series.

The third speaker is configured by a voltage-dividing resistor on an input terminal of the speaker.

Voltage-dividing resistor is differently designed for the first and second speakers such that the second speaker has phase characteristics opposite those of the first speaker and at the same time has a voltage different from the first speaker.

It is preferred that a negative terminal of the first speaker and a positive terminal of the second speaker connected to the output terminal of the speaker are connected to a volume-adjusting unit.

According to another features of the present invention for achieving the above-mentioned objects, an ear microphone is provided which comprises a connector for coupling with an external device; a control unit comprising a noise level-automatic detecting switch for selectively providing voice signal input from a first microphone (M1) or a second microphone (M2) to the connector depending on the level of voice signal; and an earphone unit comprising a first earphone part provided with a first self-balanced speaker (S3) of closed type and a second earphone part separated with the first earphone part and provided with the first microphone (M1).

In this connection, according to additional feature of the present invention, the control unit controls the noise level-automatic detecting switch in such a way that if a preset level of voice signal is above a preset value, the switch selects the first microphone (W1) and if the preset level of voice signal is below the preset value, the switch selects the second microphone (M2). Here, the preset level of voice signal may be varied.

According to yet another features of the present invention for achieving the above-mentioned objects, an ear microphone is provided which comprises a speaker outputting voice signal; and a microphone converting the voice signal into electrical signal, wherein an output terminal of the speaker and an input terminal of the microphone are positioned in the same direction.

In this connection, according to additional features of the present invention, the speaker and microphone may be positioned parallel to each other.

The ear microphone may further comprise multi-layer sound insulation member in the inside and this member may be made of rubber or sound-absorbing material.

The ear microphone may further comprise rubber or sound-absorbing material able to adjust the level of voice signal output from the speaker.

The ear microphone may further comprise a voice gain adjuster able to adjust the level of voice signal output from the speaker.

The ear microphone further comprise a housing, wherein the output terminal of the speaker and input terminal of the microphone are positioned toward an open part of the housing.

### EFFECTS OF THE PRESENT INVENTION

With application of the ear microphone of the present invention constructed as describe above, two self-balanced speakers (S1, S2) of closed type are used, and the second self-balanced speaker (S2) of closed type adjusts the output of the first self-balanced speaker (S1) of closed type to eliminate the phenomenon of echo, and resistor (R6) is connected to the output terminal of the microphone in series to adjust the output, thereby inhibiting the phenomenon of howling, whereby an effect is obtained that a clear telephone call can be made even in a noisy environment.

Furthermore, by completely separating the positions of the self-balanced speaker of closed type and directional microphone, the phenomena of echo and howling can be fundamentally eliminated which result from existing speaker and microphone being positioned close to each other, and at a place where the ambient noise is severe, the voice signal provided from the ear and shielded from the external noise while the ear microphone is worn on the ear of user is provided to the external device, whereby an effect is obtained that the degree of voice recognition of the voice-recognizing device can be increased.

Furthermore, at a place where the ambient noise is weak, provides the external device with the voice signal provided from the mouth of user while being exposed to the outside, thus an effect is obtained that unpleasant feeling can be minimized that the counterpart in calling hears a twang of the caller and stuffiness can be avoided which the user may feel due to using of a shielded ear pad.

Furthermore, by positioning the output terminal of the speaker and input terminal of the microphone in the same direction and applying rubber or sound-absorbing material, an effect is obtained that the phenomena of echo and howling is blocked in a simple way, whereby a clear sound can be heard and a problem can be solved that the voice is heard by the counterpart in a low volume, thereby causing an inconvenience in telephone call.

Furthermore, since the telephone call is made through the ear, external noise can be blocked, whereby an effect is obtained that the degree of voice recognition can be enhanced in the case the that ear microphone is applied to the voice-recognizing device(navigation, robot control, voice recognition of mobile phone).

### BRIEF DESCRIPTION OF THE DRAWINGS

FIG. 1 is a view showing a general worn state of an ear microphone.

FIG. 2 is a view showing a schematic construction of a conventional ear microphone.

FIG. 3 is a view showing a schematic construction of another conventional ear microphone.

FIG. 4 is a view showing a schematic construction of an ear microphone according to a first example of the present invention.

FIG. 5 is a circuit diagram showing a detailed construction of a control unit illustrated in FIG. 4.

FIG. 6 is a view showing a schematic construction of an ear microphone according to a second example of the present invention.

FIG. 7 is a circuit diagram showing a detailed construction of a control unit illustrated in FIG. 6.

FIG. 8 is a view showing a structure of the ear microphone to which the present invention is applied.

FIG. 9 is a view showing the inside of a housing of the ear microphone according to the present invention.

FIG. 10 is a view showing a speaker-accommodating recess of the ear microphone according to the present invention and a space formed in the speaker-accommodating recess.

FIG. 11 is a view showing an external shape of sound-absorbing material or rubber of the ear microphone according to the present invention.

FIG. 12 is a view for explaining a function of a through recess in the sound-absorbing material or rubber of the ear microphone according to the present invention.

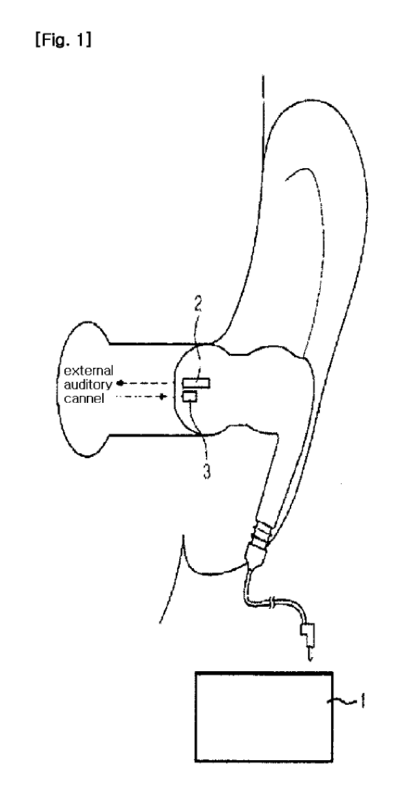

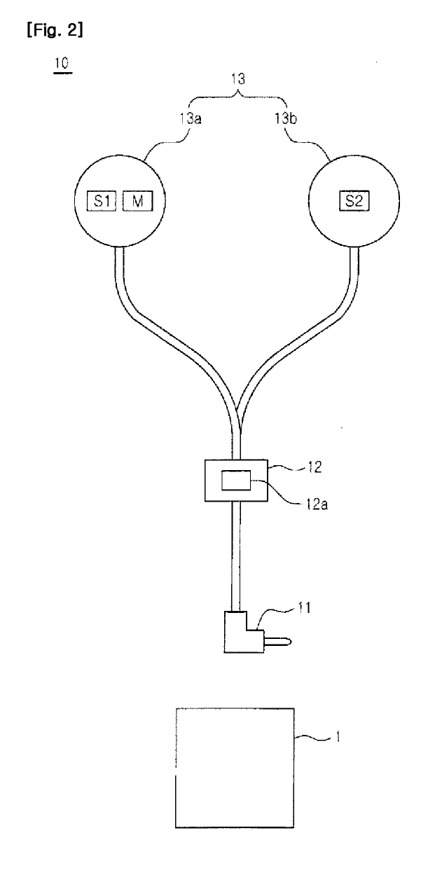

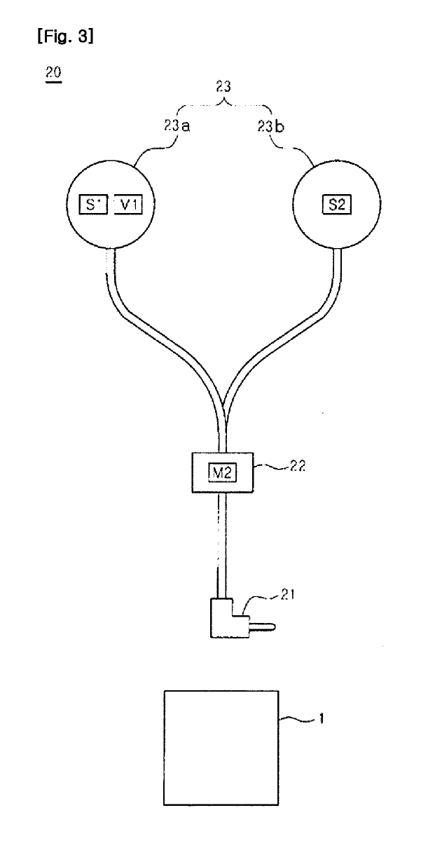

### MODES FOR CARRYING OUT THE INVENTION

In the following, ear microphones according to preferred examples of the present invention will be described in detail with reference to the attached drawings.

However, the scope of the present invention is not limited by the examples represented in the specification of the present invention, and it should be understood that various modification and variation may be made by those having ordinary skill in the field of art to which the present invention belongs within technical concepts of the present invention and the scope of equivalent of the claims described below.

Furthermore, in describing the examples, a description will be omitted of technical content that is well known in the field of art to which the present invention belongs and does not have a direct relation with the present invention. Such omission is intended to more clearly deliver the gist of the present invention without obscuring it by omitting unnecessary description.

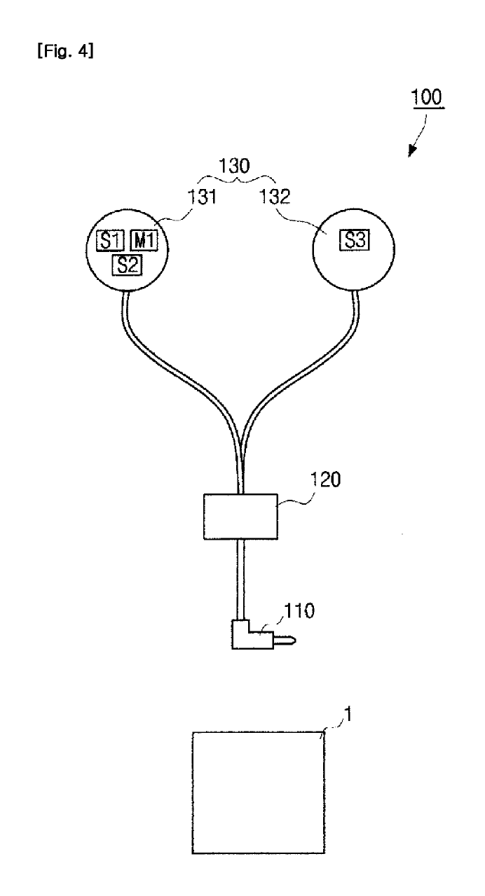

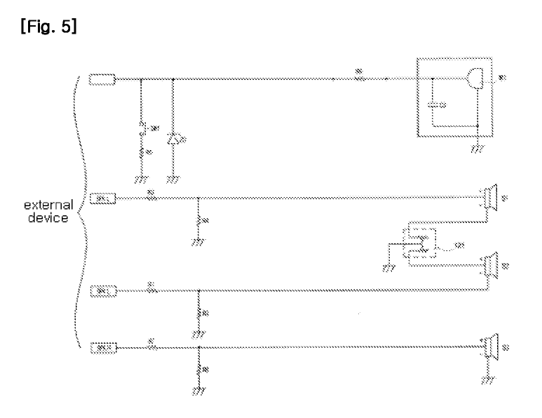

FIG. 4 of the attached drawings is a view showing a schematic construction of an ear microphone according to a first example of the present invention, and FIG. 5 is a circuit diagram showing a detailed construction of a control unit illustrated in FIG. 4.

As illustrated in FIGS. 4 and 5, the ear microphone (100) according to the present invention comprises a connector (110) for coupling with an external device (1), a control unit (120) for controlling the ear microphone (100) overall, and an earphone unit (130) worn on the ear of user and carrying out the voice-outputting or inputting process. Here, the connector (110), control unit (120) and earphone unit (130) are electrically connected to one another through certain cables.

The connector (110) may be in any various forms allowing connection to the external device (1). The connector (110) provides signal provided from the external device (1) to the control unit (120), and provides signal provided through the control unit (120) to the external device (1).

The control unit (120) comprises a volume-adjusting unit 121 for adjusting the volume of voice signal output by a first, second and third speakers (S1, S2, S3) provided in the earphone unit (130). Here, the first, second and third speakers (S1, S2, S3) are speaker of balanced-armature type.

The ear microphone unit (130) is comprised of first and second earphone parts (131, 132) of a shape allowing the parts to be worn on both ears of user. The first earphone part (131) is provided with the first and second speakers (S1, S2) and a first microphone (M1), and the second earphone part (132) is provided with the third speaker (S3).

The first microphone (M) is provided with, as input signal, signal generated from the ear when the user talks, and is preferably comprised of a microphone having a directional property. That is to say, the voice signal provided from the external device (1) is transmitted to the ears of user through the first, second and third speakers (S1, S2, S3) provided in the first and second earphone parts (131, 132).

Also, the voice signal of user is transmitted to the first microphone (M1) through the external auditory cannel of the ear and then provided to the external device (1).

Furthermore, the control unit (120) comprises a ground terminal, a speaker output terminal of which one end is coupled with the connector (110) and of which the other end is coupled with the first and second speakers (S1, S2), and a microphone input terminal of which one end is coupled with the connector (110) and of which the other end is coupled with the first microphone (M1).

Furthermore, a smoothing capacitor (C3) for preventing ripple is connected to transmission path between the first microphone (M1) and first switch (SW1) in parallel.

For the speaker output terminal, voltage-dividing resistors (R1, R2) are coupled on a transmission path between the connector (110) and second speaker (S2), and voltage-dividing resistors (R3, R4) are couple d on a transmission path between the connector (110) and first speaker (S1). Furthermore, voltage-dividing resistors (R7, R8) are coupled on a transmission path between the connector (110) and third speaker (S3).

Also, one end of each of the first and second speakers (S1, S2) is coupled with the volume-adjusting unit (121). This volume-adjusting unit (121) may be comprised of a variable resistor, and depending on its value of resist, varies the level of voice signal output by the first and second speakers (S1, S2).

A resistor (R6) is connected in series between the input terminal of microphone and the connector (110).

A switch (SW1) is coupled with a transmission path between the connector (110) and the resistor (R6), which switch is connected with a resistor (R5) in series while the other end of the switch is grounded, and in addition, a Zener diode (ZD) is coupled with the transmission path, which diode is connected with the first switch (SW1) in parallel and the other end of the diode is grounded.

For the ear microphone (100) according to the example of the present invention as described above, the first earphone part (131) comprises the two speakers (S1, S2) and output signal of the first speaker (S1) is adjusted by imparting different input signal and phase for each of the speakers (S1, S2), hence the phenomenon of echo is reduced which is generated since the voice signal coming out from the first speaker (S1) is input to the first microphone (M1), whereby a clear telephone call with the counterpart is possible. Furthermore, there is connected an output resistor (R6) for adjusting output signal of the first microphone (M1) of the first earphone part (131), therefore, the howling can be inhibited which is generated since the first and second speakers (S1, S2) and the first microphone (M1) are positioned close to each other.

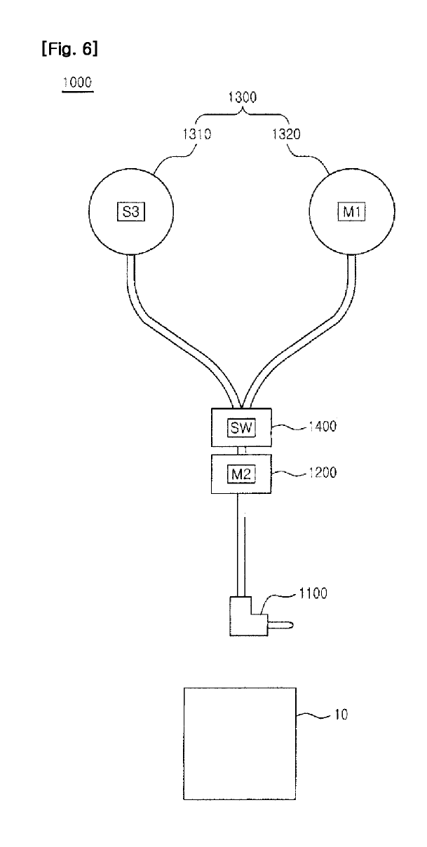

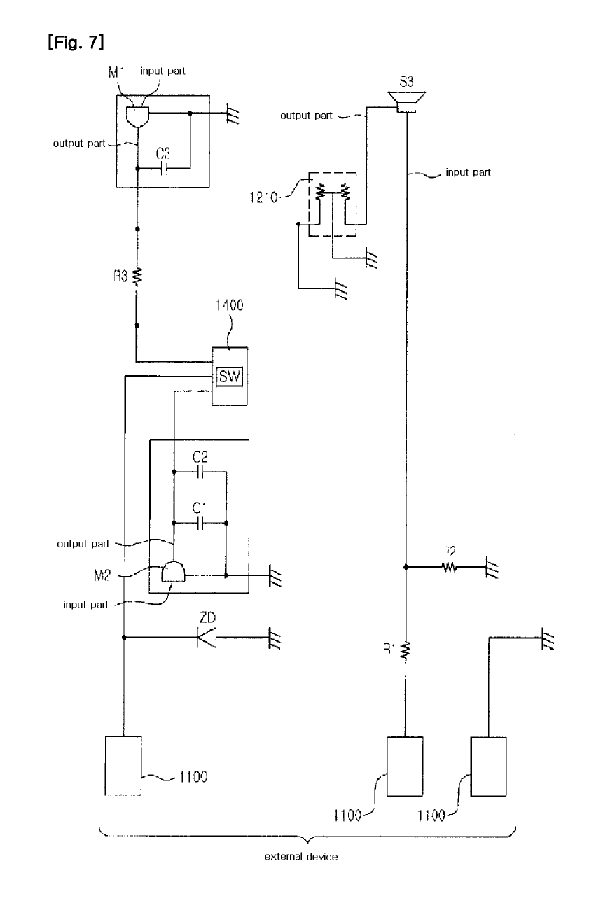

Meanwhile, FIG. 6 of the attached drawings is a view showing a schematic construction of an ear microphone according to a second example of the present invention, and FIG. 7 is a circuit diagram showing a detailed construction of a control unit illustrated in FIG. 6.

As illustrated in FIG. 6, the ear microphone (1000) according to the present invention comprises a connector (1100) for coupling with an external device (10), a control unit (1200) for controlling the ear microphone (1000) overall, a noise level-detecting switch (1400) which is automatically switched according to the level of ambient noise, and an earphone unit (1300) worn on the ear of user and carrying out the voice-outputting or inputting process and comprising a first earphone part (1310) and a second earphone part (1320). Furthermore, inside or outside the second earphone part (1320), the ear microphone (1000) according to the present invention may further comprise an amplifier for amplifying the voice signal coming out from the second earphone part (1320) if this signal is weak. Here, the connector (1100), control unit 1200), noise level-automatic detecting switch (1400), and earphone unit (1300) are electrically connected to one another through certain cables

The connector (1100) may be in any various forms allowing connection to the external device (10). The connector (1100) provides signal provided from the external device (10) to the control unit (1200), and provides signal provided through the control unit (1200) to the external device (10).

The control unit (1200) comprises a second microphone (M2) and a volume-adjusting unit (1210; illustrated in FIG. 7)for adjusting the volume of voice signal output by a self-balanced speaker (S3) of closed type provided in the first earphone unit (1310). In this connection, the second microphone (M2) is positioned so as to be exposed to the outside and is intended to receive the voice signal provided from the mouth of user and is preferably comprised of a microphone having no directional property.

Furthermore, the noise level-automatic detecting switch (1400) is electrically connected with the first and second microphones (M1, M2) and automatically connected depending on the level of ambient noise. Namely, the control unit (1200) can control the noise level-automatic detecting switch (1400) in such a way that if the level of voice signal preset by the user is above the preset value (for example, 70 dB), the switch selects the first microphone (M1), and if the level of voice signal is below the preset value, the switch selects the second microphone M2), In this connection, the user can variously set the level of voice signal, noise etc. by his/her own selection.

For the earphone unit (1300), a first self-balanced speaker (S3) of closed type is provided in the first earphone part (1310) of a shape allowing the part to be worn on one ear of user, and the first microphone (M1) is provided in the second earphone part (1320) of a shape all owing the part to be worn on the other ear of user. The first microphone (M1) is provided with, as input signal, signal generated from the ear when the user talks, and is preferably comprised of a microphone having a directional property. That is to say, the voice signal provided from the external device (10) is transmitted to the ear of user through the first self-balanced speaker (S3) of closed type provided in the first earphone part (1310). Also, the ambient noise is above a specific level that is a value set by the user, the voice signal is transmitted through the external auditory cannel of the ear to the first microphone (M1) and is then provided to the external device (10). In this connection, the first self-balanced speaker (S3) of closed type provided in the first earphone part (1310) may have a impedance of 200 Ω or more.

Here, the first and second earphone parts (1310, 1320) of the earphone unit (1300) may have an outer part formed of silicone in order to block noise resulting from an influence of wind and block ingress of water.

With reference to FIG. 7, an output part of the first self-balanced speaker (S3) of closed type is coupled with the volume-adjusting unit (1210) and an input part of the speaker is electrically coupled with the connector (1100). Furthermore, the connector (1100) is electrically coupled with output parts of the first and second microphones (M1, M2). The noise level-automatic detecting switch (1400) is selectively coupled with the output part of the first microphone (M1) or second microphone (M2), and the output terminal of the microphone coupled with the noise level-automatic detecting switch (1400) is coupled with the connector (1100). Here, smoothing capacitors (C1, C2) for preventing the ripple are connected to a transmission path between the second microphone (M2) and the noise level automatic detecting switch (1400) in parallel. Furthermore, if the noise above a fixed level is generated, the noise level-automatic detecting switch (1400) detects such noise and then selectively provides the connector (1100) with the voice signal coming from the first or second microphone (M1, M2).

In the following, operation of the ear microphone according to the present invention constructed as described above will be described.

The noise level-automatic detecting switch (1400) determines whether to select the first microphone (M1) or second microphone (M2) as a voice signal inputting means considering the ambient noise in a place where the caller is located. That is to say, in the case where the ambient noise is severe, the noise-level automatic detecting switch (1400) automatically selects the first microphone (M1), and accordingly the telephone call is made by the ear, and in the case where the ambient noise is not severe, the noise level-automatic detecting switch (1400) selects the second microphone (M2), and accordingly the voice signal is transmitted to the counterpart.

That is to say, according to the present invention, an ear microphone can be provided which at a place where the ambient noise is severe, provides the external device with the voice signal provided from the ear and shielded from the external noise while being worn on the ear and at a place where the ambient noise is weak, provides the external device with the voice signal provided from the mouth of user while being exposed to the outside.

That is to say, since the user provides the counterpart with the voice signal coming out from his/her mouth at a place where the ambient noise is not severe, unpleasant feeling can be minimized that the counterpart in calling hears a twang of the user, and stuffiness can be avoided which the user may feel due to using of a shielded ear pad over a long time. Furthermore, by completely separating the microphone and speaker, the user hears the voice of counterpart through the speaker by one ear and speaks with the counterpart through the microphone by the other ear, whereby the phenomena of echo and howling can be fundamentally eliminated which result from the speaker and microphone being positioned close to each other. Furthermore, by using the self-balanced speaker of closed type, the speaker can be completely shielded, thereby preventing the ingress of external noise, whereby the degree of voice recognition of the voice-recognizing device can be increased

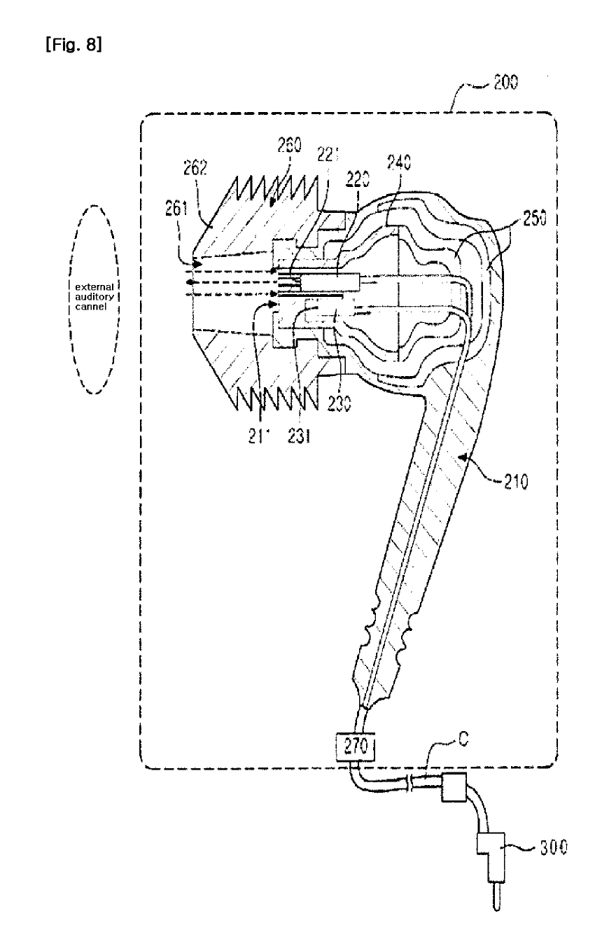

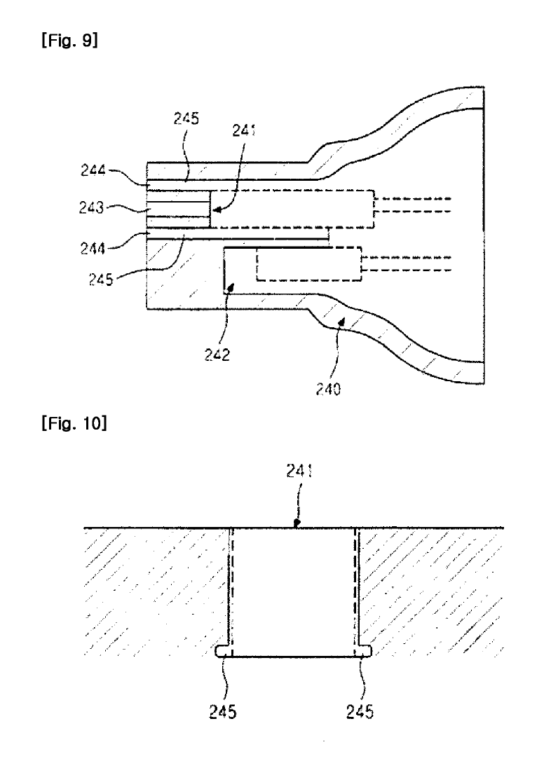

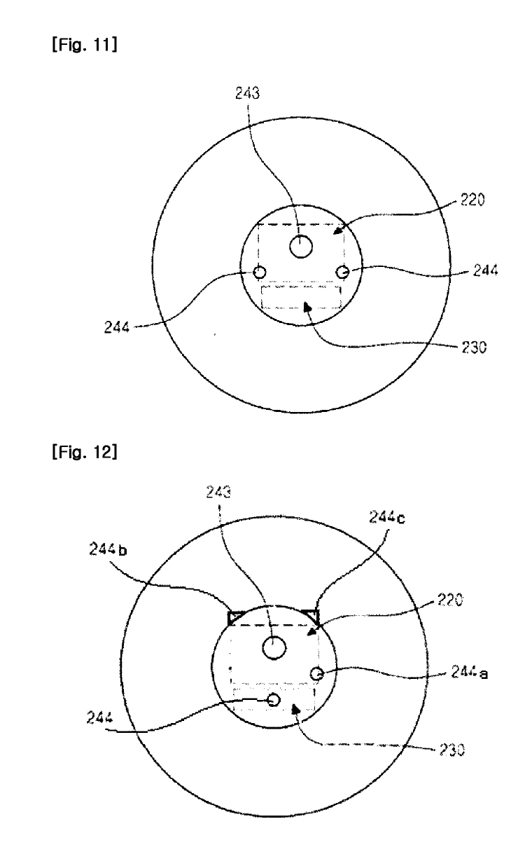

Meanwhile, FIG. 8 of the attached drawing is a view showing a structure of the ear microphone to which the present invention is applied, FIG. 9 is a view showing the inside of a housing of the ear microphone according to the present invention, FIG. 10 is a view showing a speaker-accommodating recess of the ear microphone according to the present invention and a space formed in the speaker-accommodating recess, FIG. 11 is a view showing an external shape of sound-absorbing material or rubber of the ear microphone according to the present invention, and FIG. 12 is a view for explaining a function of a through recess in the sound-absorbing material or rubber of the ear microphone according to the present invention.

With reference to FIG. 8, the ear microphone according to the present invention comprises a connector (300) coupled with the external device and a main body (200) of a shape allowing it to be worn on the ear of user. In this connection, the connector (200) and main body (200) are connected to each other through a cable (C).

The main body (200) comprises a speaker (220) and a microphone (230) which are arranged in an approximate [symbol] —shaped housing (210) of a size allowing it to be inserted into the ear of user. Here, formed in a surface of the housing (210) facing the external auditory cannel at a central portion of the surface is an open part (211) of the housing for inputting and outputting the voice signal.

The speaker (220) converts electrical signal provided from the external device through the connector (300) into the voice signal to output it. In this connection, the speaker (220) is a self-balanced speaker of closed type (balanced armature-type speaker) and characterized in that it has more voice support and higher durability than dynamic speaker.

The microphone (230) converts the voice signal of user provided through the external auditory cannel into electrical signal and then output it to the connector (300). For example, for the microphone (230) according to the present invention, a capacitor microphone with halls at a rear surface thereof is possible.

While the speaker (220) and microphone (230) are positioned parallel to each other, the speaker (220) and microphone (230) are fixedly supported inside the housing (210) by the sound-absorbing material (240) for supporting the speaker and microphone. In this connection, rubber may be used in place of the sound-absorbing material (240).

Furthermore, as illustrated in FIG. 8, the voice signal output terminal (221) of the speaker (220) and voice signal input terminal (231) of the microphone (230) are positioned so as to face toward the same direction. That is to say, the output terminal (221) of the speaker (220) and the input terminal (231) of the microphone (230) are positioned toward the open part (211) of the housing (210). It can mean that the output terminal (221) of the speaker (220) and the input terminal (231) of the microphone (230) are positioned so as to face toward the same direction as the surface facing the external auditory cannel.

Conventionally, in the case where opposite direction disposition is commonly employed for preventing the voice signal output from the output terminal of the speaker from flowing into the input terminal of the microphone (230), there is an inconvenience that the voice is heard by the counterpart in a low volume due to a long passageway leading to the microphone.

Even if the output terminal (221) of the speaker (220) and the input terminal (231) of the microphone (230) are positioned in the same direction, the ear microphone according to the present invention can deliver clearer voice using the sound-absorbing material (240) or rubber and a voice gain adjuster (270).

Meanwhile, sound insulation covers (250) for shielding the noise are formed in plural layers inside the housing (210). In this connection, the sound insulation covers (250) may be formed in a two-layer structure on an external auditory cannel side and in a three-layer structure on an opposite side with respect to the speaker (220) and microphone (230).

Furthermore, a cover (260) for close contact with the inside of the ear of user is formed on an outer part of the housing (210) on the external auditory cannel side. This cover (260) wraps a part of the housing (210) on the external auditory cannel side, and is formed on its outside with a plurality of protrusions (262) and at its central portion with an open recess (261) having a diameter smaller than the diameter of the open part (211) of the housing (210) and communicating with the open part (211). In this connection, the cover (260) is contacted with the inside of ear of user and may be constructed of material soft to the touch and having close contactibility, for example, silicone.

With reference to FIGS. 9 to 11, the sound-absorbing material (240) is in the form of a step-like cylinder and a speaker-accommodating recess (241) for disposition of the speaker (220) and a microphone-accommodating recess (242) for disposition of the microphone (230) are formed inside the sound-absorbing material. Here, the speaker-accommodating recess (241) and the microphone-accommodating recess (242) each have a purpose of securing the speaker (220) and the microphone (230) in order to minimize vibration due to the influence of external wind or mechanical vibration noise generated from mechanism inside the main body (200).

Also, a first through recess (243) for transmission of the voice signal to the external auditory cannel is formed at a bottom of the speaker-accommodating recess (241), i.e., a central portion of a surface facing the external auditory cannel, and second through recesses (244) are also formed at both sides of the bottom for transmitting the voice signal provided from the external auditory cannel to the inside of the sound-absorbing material (240). In this connection, the second through recesses (244) are constructed so as to communicate with the speaker-accommodating recess (242), and this speaker accommodating recess (242) is constructed so as to form spaces (245) that communicate with the second through recesses (244) in the state of the speaker (220) being positioned as illustrated in FIG. 10. It has such a purpose that the voice signal input from the external auditory cannel through the second through recesses (244) is transmitted through the spaces (245) formed in the speaker-accommodating recess (242) to the inside of the sound-absorbing material (240) and is then provided to the input terminal of the microphone (230). That is to say, the spaces (245) formed in the speaker-accommodating recess (242) are a transmission passageway for the voice signal provided from the external auditory cannel. FIG. 11 shows external shape of the sound-absorbing material (240) viewed from the side of external auditory cannel. That is to say, the first and second through recesses (243, 244) are formed at the surface of the sound-absorbing material (240) facing the external auditory cannel

Meanwhile, as illustrated in FIG. 12, the second through recesses 244, 244a, 244b, 244c) for providing the voice signal input from the external auditory cannel to the input terminal of the microphone (230) may be adjusted in its position and number.

The second through recesses designated by reference numeral “244” function to receive and provide the voice signal via a front surface of the microphone (230), and the second through recesses designated by reference numerals “244a, 244b, 244c” function to receive and provide the voice signal via a rear surface of the microphone (230), This case is applied to only a case where a back hole is present in the microphone, and therefore, in the case where a microphone without the back hole is used, the second through recesses designated by reference numerals “244a, 244b, 244c” have no significance.

Next, operations of the microphone constructed as described above will be described.

First, in the state that the connector (300) of the ear microphone is coupled with an external device, for example, a mobile communication terminal, the electrical signal provided from the mobile communication terminal is provided to the speaker (220) of the main body (200) through the connector (300) and cable (C). The speaker (220) converts the electrical signal applied from the mobile communication terminal into the voice signal and then output the voice signal through the output terminal. The voice signal output through the output terminal of the speaker (220) is transmitted to the external auditory cannel through the first through recess (241) of the sound-absorbing material (240) and the open part (211) of the housing (210) and the open recess (262) of the cover (260).

Furthermore, the voice signal generated by the user flows through the external auditory cannel, the open recess (262) of the cover (260), the open part (211) of the housing (210) and the second through recess (242) of the support member (240) into the space (245) of the sound-absorbing material (240), and the voice signal transmitted through this space (245) flows into the input terminal (231) of the microphone (230). At this time, although the input terminal (231) of the microphone (230) is positioned in the same direction as the output terminal (221) of the speaker (220), thanks to the sound-absorbing material (240) that absorbs a constant volume of sound, the input terminal of the microphone is not influenced by the output signal of the speaker (220), whereby the phenomenon of howling or echo is automatically prevented.

Therefore, according to the present invention, even with a simple method wherein the output terminal of the speaker and the input terminal of the microphone are positioned so as to face toward the same direction, by using the sound-absorbing material (240), the phenomenon of echo is blocked which is generated by the voice signal of the output terminal of speaker flowing into the input terminal of the microphone. Furthermore, by solving a problem that the voice is heard by the counterpart in a low volume since the output terminal of the speaker and the input terminal of the microphone are positioned in a direction opposite each other, the degree of voice recognition of the voice-recognizing device is drastically improved through the ear microphone.

What is claimed:

1. An ear microphone comprising:
a connector for coupling with an external device;
a control unit for controlling the ear microphone overall; and
an earphone unit worn on the ear of user and carrying out voice-outputting or inputting process,
wherein the connector, control unit and earphone unit are electrically connected to one another through cables, and
the earphone unit has a shape allowing it to be worn on the ear of user and comprises a first earphone part which includes first and second speakers and a first microphone having a directional property and a second earphone part which includes a third speaker, and
the control unit comprises a ground terminal, a element of which one end is coupled with the connector and of which the other end is coupled with the first, second and third speakers, and an element of which one end is coupled with the connector and of which the other end is coupled with the first microphone,
an output terminal of the microphone is connected to a resistor in series, and the third speaker is configured by a voltage-dividing resistor on an input terminal of the speaker, and voltage-dividing resistor is differently designed for the first and second speakers such that the second speaker has phase characteristics opposite those of the first speaker and at the same time has a voltage different from the first speaker, and
a negative terminal of the first speaker and a positive terminal of the second speaker connected to the output terminal of the speaker are connected to a volume-adjusting unit.

2. An ear microphone comprising:
a connector for coupling with an external device;
a control unit comprising a noise level-automatic detecting switch for selectively providing voice signal input from a first microphone (M1) or a second microphone (M2) to the connector depending on the level of voice signal; and
an earphone unit comprising a first earphone part provided with a first self-balanced speaker (S3) of closed type and a second earphone part separated with the first earphone part and provided with the first microphone (M1),
wherein the control unit controls the noise level-automatic detecting switch in such a way that if a preset level of voice signal is above a preset value, the switch selects the first microphone (M1) and if the preset level of voice signal is below the preset value, the switch selects the second microphone (M2).

3. An ear microphone comprising:
a connector for coupling with an external device;
a control unit comprising a noise level-automatic detecting switch for selectively providing voice signal input from a first microphone (M1) or a second microphone (M2) to the connector depending on the level of voice signal; and
an earphone unit comprising a first earphone part provided with a first self-balanced speaker (S3) of closed type and a second earphone part separated with the first earphone part and provided with the first microphone (M1),
wherein the ear microphone further comprises an amplifier for amplifying the voice signal coming out from the second earphone part.

4. An ear microphone comprising:
a speaker outputting voice signal;
a microphone converting the voice signal into electrical signal; and
a sound-absorbing material or rubber for positioning the speaker and microphone,
wherein an output terminal of the speaker and an input terminal of the microphone are positioned in the same direction, and
the sound-absorbing material or rubber comprises a first through recess for transmitting the voice signal output from the output terminal to an external auditory cannel and a second through recess for transmitting the voice signal provided from the external auditory cannel to the input terminal.

5. The ear microphone according to claim 4, wherein the speaker and microphone are positioned parallel to each other, or the ear microphone further comprises the sound-absorbing material or rubber as multi-layer sound insulation member in the inside or further comprises a voice gain adjuster able to adjust the level of voice signal output from the speaker or further comprises a housing, wherein the output terminal of the speaker and input terminal of the microphone are positioned toward an open part of the housing.
